(19) United States
(12) Patent Application Publication
(10) Pub. No.: US 2026/0358518 A1
(43) Pub. Date: Nov. 12, 2026

(54) METHOD FOR PREDICTING FAULT SEAL BEHAVIOUR

(71) Applicant: SHELL USA, INC., Houston, TX (US)

(72) Inventors: John SOLUM, Houston, TX (US); Pedram ZARIAN, Houston, TX (US); Donald Paul GRIFFITH, Houston, TX (US); Russell David POTTER, Houston, TX (US)

(21) Appl. No.: 19/118,429

(22) PCT Filed: Nov. 9, 2023
(86) PCT No.: PCT/EP2023/081358

§ 371 Date: Apr. 4, 2025

Related U.S. Application Data
(60) Provisional application No. 63/383,102, filed on Nov. 10, 2022.

(51) Int. Cl. G01V 1/28; G01V 1/30

(52) U.S. Cl. CPC G01V 1/282; G01V 1/301; G01V 1/308; G01V 2210/612; G01V 2210/614; G01V 2210/642; G01V 2210/644

(57) ABSTRACT

A method for predicting fault seal behaviour involves training a backpropagation-enabled process using a training data set of seismic data, well data, and training labels. The seismic data has at least three spatial dimensions and a seismic resolution. The well data has a vertical resolution greater than the seismic resolution. The training data set is used for training the process to predict a contained column height and/or a fluid flow capacity at a fault juxtaposition location. The trained backpropagation-enabled process is used in a non-training data set to predict a contained column height and/or a fluid flow capacity at a fault juxtaposition location.

### FIELD OF THE INVENTION

The present invention relates to backpropagation-enabled processes, and in particular, to a method for predicting fault seal behaviour using a backpropagation-enabled process.

### BACKGROUND OF THE INVENTION

Fault seal analysis is important in hydrocarbon exploration and production, as well as in the selection of suitable subsurface formation for carbon sequestration. For these activities, it is important to understand the extent to which a fluid will migrate across a fault or be trapped by a fault.

One method of performing a fault seal analysis is to use a juxtaposition diagram, such as an Allan diagram (Allan, “Model for hydrocarbon migration and entrapment within faulted structures” AAPG Bulletin 73: 7: 803-811; 1989), to predict which traps have a high probability of containing hydrocarbons and the amount of hydrocarbons a trap can contain. A challenge with using a juxtaposition diagram is that the process is time-consuming. Accordingly, efforts have been made to predict fault seal behaviour using a computer model.

For example, Viard et al. (U.S. Pat. No. 10,209,380B2, 19 Feb. 2019) describes a method for juxtaposition across a geological discontinuity, such as a fault, by identifying the discontinuity in a set of seismic data and parameterizing each side of the discontinuity with first and second parameters. Isolines of each parameter are determined and used to divide the surface of the discontinuity. Overlapping areas of the divided surfaces are summed to model flow through the discontinuity.

Generally, fault seal analyses may be static or dynamic.

Static fault seal is the ability of a fault to maintain a column over geologic timescales. Apparent static seal can be calculated by measuring the column height and buoyancy pressure difference across a reservoir/reservoir juxtaposition.

As an example of a static fault seal analysis, Liu et al. (U.S. Pat. No. 10,634,805B2, 28 Apr. 2020) relates to a method for predicting fault seal based on a digital seismic image. A fault coordinate system is defined parallel and perpendicular to a fault surface. Seismic amplitudes are extracted from a sub-volume surrounding the fault surface and are mapped in the fault coordinate system. Trace fitting of the seismic amplitudes is performed along directions locally perpendicular to the fault surface to separate fault seismic signal from other seismic energy. The fault seismic signal from the trace fitting is compared to a natural analogue and/or a synthetic model of responses to generate a predicted fault seal.

Dynamic fault seal is the ability of a fault to maintain a cross-fault pressure difference over the timescale during which hydrocarbons are injected and/or produced from a field. Conventional approaches are based on hydrocarbon production rate history-matching studies that report faults as either sealing, partially sealing, or open. Some examples of dynamic fault seal analysis are more quantitative, and report actual transmissibility multipliers used for history-matching or production-induced cross-fault pressure differences.

Myers et al. (U.S. Pat. No. 8,793,110B2, 29 Jul. 2014) provide that the current practice of evaluating effects of fault zone materials on cross-fault flow by a Shale Gouge Ratio (SGR) or Clay Smear Potential (CSP) is limited by predictive capability and robustness. Myers et al., therefore, aim to address the conventional problems of requiring local calibration of SGR to fault permeability, and failure to consider apparent low permeability of faults in high N:G sections.

Accordingly, Myers et al. describe a dynamic seal analysis method for predicting fluid flow by predicting a volume of shale in a fault, calculating the thickness of the fault, and calculating the permeability of the fault based on the shale volume, thickness, an estimated shale smear continuity and cataclastic reduction factors.

Many conventional approaches are limited to clastic formations. As discussed by Solum (“Static and dynamic fault seal potential in carbonates” Paper Wo FTS 05, presented at EAGE Fourth International Conference on Fault and Top Seals; Alméria, Spain, 20-24 Sep. 2015), fault seal analysis for carbonates is more complicated than for faulted clastics due to the greater chemical reactivity of carbonates, and requires integration of geochemistry/diagenesis with structural geology.

Solum et al. (“Toward the creation of models to predict static and dynamic fault-seal potential in carbonates” Petroleum Geoscience 23: 70-91; 2017) provides a summary of carbonate reservoirs with cross-fault height difference that represent examples of fault seal.

There remains a need for improving the accuracy of fault seal behaviour predictions, and for improving the time required to interpret data for generating a prediction.

### SUMMARY OF THE INVENTION

According to one aspect of the present invention, there is provided a method for predicting fault seal behaviour, comprising the steps of: providing a training data set of seismic data, well data, and associated labels, wherein the seismic data has at least three spatial dimensions and a seismic resolution, and wherein the well data has a vertical resolution greater than the seismic resolution; training a backpropagation-enabled process using the training data set to predict one or more of a contained column height and a fluid flow capacity at a fault juxtaposition location, thereby producing a trained backpropagation-enabled process; and using the trained backpropagation-enabled process in a non-training data set to predict one or more of a contained column height and a fluid flow capacity at a fault juxtaposition location.

### DETAILED DESCRIPTION OF THE INVENTION

The present invention provides a method for predicting fault seal behaviour. A training data set is used for training a backpropagation-enabled process to predict a contained column height and/or a fluid flow capacity at a fault juxtaposition location. The trained backpropagation-enabled process is then used on a non-training data set to predict a contained column height and/or a fluid flow capacity at a fault juxtaposition location.

By “contained column height,” we mean the vertical distance between a hydrocarbon/water contact location and a fault juxtaposition location. Since hydrocarbons such as oil and natural gas are less dense than water, this contained column exerts a buoyancy pressure, the magnitude of which increases with the column height.

By “fluid flow capacity,” we mean the extent to which the flow of a fluid across a fault is inhibited. Fluid flow is controlled by the permeability and thickness of the materials comprising the fault zone.

By “fault juxtaposition location,” we mean a location in the subsurface where there is a bedding plane discontinuity across which there is cross-fault reservoir/reservoir juxtaposition.

The training data set comprises seismic data, well data, and associated labels. Preferably, the seismic data and the well data are representative of the same fault. The seismic data has a seismic resolution, and the well data has a vertical resolution greater than the seismic resolution. While the seismic resolution can be used to locate a fault, details about a fault are often not discernible from seismic resolution. Effective fault analysis includes an understanding of, for example, without limitation, fault heave, fault orientation, lithologies, and combinations thereof. Fault heave and layer thicknesses will impact the rate of transmissibility of fluids across a fault, as well as the ability for a fault to seal a reservoir against fluid transmission.

The seismic data has at least three spatial dimensions to enable the backpropagation-enabled process to predict the presence of a fault surface, which has three dimensions.

A seismic array is an example of 3D seismic data, while pre-stack seismic response data may be 4D and/or 5D. An example of 6D data may be 5D data with time-lapse data.

Seismic response data may be field-acquired and/or simulated seismic data from multiple field or simulated source locations and/or multiple field or simulated receiver locations. Seismic response data includes, for example, without limitation, single offset, multiple offsets, single azimuth, multiple azimuths, and combinations thereof for all common midpoints of field-acquired and/or simulated seismic data. 4D-6D data may also be 3D seismic data with attributes related to seismic survey acquisition or the result of multiple attribute computations.

As an example, multiple attributes preferably comprise 3 colour channels. The seismic response data may be measured in a time domain and/or a depth domain. A 3D data set may, for example, be 3D seismic data or 3D data extracted from seismic data of 4 or more dimensions. And the 4D data set may, for example, be 4D seismic data or 4D data extracted from seismic data of 5 or more dimensions.

Examples of attributes include, without limitation, spectral content, energy associated with changes in frequency bands, signals associated with filters, such as, for example, noise-free filters, low-pass filters, high-pass filters, and band-pass filters, acoustic impedance, reflectivity, semblance, loop-based properties, envelope, phase, dip, azimuth, curvature, and combinations thereof.

Three-colour channels, with or without brightness, transparency, or alpha channels, include, without limitation, RGB, RGB-A, CIEXYZ, CIELAB, CMYK, HSL and HSV colour spaces. Another example is described in Griffith (U.S. Pat. No. 10,249,080B2, 2019 Apr. 2 and U.S. Pat. No. 10,614,618B2, 2020 Apr. 7).

The vertical resolution of seismic data is dependent on wavelength, which is a function of wave velocity and frequency. Seismic wave velocities in the subsurface range from 2000 to 5000 m/s, generally increasing with depth. Meanwhile, the dominant frequency of a seismic signal is typically in a range from 20 to 50 Hz, generally decreasing with depth. Accordingly, the seismic wavelength is typically in a range from 40 to 250 m, generally increasing with depth.

Well data is provided to provide and/or infer subsurface physical properties and/or reservoir parameters. Well data is typically collected along the depth of at least a portion of a well, for example, during exploration, assessment, drilling, and completion. The well data includes, without limitation, well log data, downhole fluid sampling, flow test, injectivity test, stress test, tracer testing, borehole imaging, core samples, and combinations thereof. Well log data may include, for example, without limitation, acoustic logs, calliper logs, chemical logging, density logs, gamma logs, image logs, mud logging, neutron logging, pressure temperature logs, single-well and cross-well resistivity logs, and combinations thereof. An image log may be acquired, for example, using a chemically-selective imager as disclosed in Appel et al. (U.S. Pat. No. 10,481,291B2, 2019 Nov. 19).

The well data may be 1D or greater. The well data resolution has a vertical resolution greater than the seismic data resolution. Preferably, the resolution of the well data is such that the resolved scale of the data is less than ½ of the wavelength of the seismic data. More preferably, the resolution of the well data is such that the resolved scale of the data is less than ¼ of the wavelength of the seismic data.

In other terms, whereas the seismic data may have a resolution that is in range of from 10 to 250 m, the well data may have a resolution that is in a range of from 1 cm to 5 m, preferably in a range of from 1 cm to 2.5 m, more preferably in a range of from 1 cm to 1 m.

Depending on the type and resolution of the well data, it may be advantageous to downscale the well data to reduce computational resources.

In addition to the seismic data, well data, and associated labels, the training data set may include geologically realistic parameters that may be inferred directly or indirectly from the seismic data and/or well data. Examples of geologically realistic parameters include, without limitation, scaling relationships, burial depth, stress state, reactivation history, temperature, diagenesis, and combinations thereof. For example, a scaling relationship may be inferred from fault displacement, which for example may be inferred from the seismic data and/or the well data. The geologically realistic parameters may be calculated before being added to the training data set. Alternatively, the backpropagation-enabled process may be trained to calculate one or more geologically realistic parameter from the seismic and/or well data.

The seismic and/or well data in the training data set may be selected from field-acquired data, synthetically generated data, augmented data, and combinations thereof.

Synthetic data may be generated, for example, without limitation, according to Griffith et al. (US2021/0223422A1 and/or US2021/0223423A1, 2021 Jul. 22) and/or according to Zarian et al. (WO2021/259912A1, 2021 Dec. 30).

For field-acquired data, the associated labels are manually generated, while labels for simulated data are automatically generated. The generation of labels, especially manual label generation, is time-intensive and requires expertise and precision to produce an effective set of labels.

By augmented data, we mean field-acquired and/or synthetically generated data that is modified, for example, by conventional DL data-augmentation techniques, as described in Taylor et al. (“Improved deep learning with generic data augmentation” IEEE Symposium—Symposium Series on Computational Intelligence SSCI 2018 1542-1547; 2018) which describes conventional augmenting by geometrical transformation (flipping, cropping, scaling and rotating) and photometric transformations (amending colour channels to change lighting and colour by colour jittering and Fancy Principle Component Analysis). Augmented data may also be generated, for example, as described in Liu et al. (US2020/0183035A1, 2020 Jun. 11), which relates to data augmentation for seismic interpretation, recognizing that standard data augmentation strategies may produce limited plausible alternative samples and/or may lead to geologically or geophysically infeasible to implausible alternative samples. The machine learning method involves extracting patches from input data and transforming that data based on the input data and geologic and/or geophysical domain knowledge to generate augmented data.

Transforming data is selected from an identity transformation, a spatial filter, a temporal filter, an amplitude scaling, a rotational transformation, a dilatational transformation, a deviatoric transformation, a resampling using interpolation or extrapolation, a spatial and temporal frequency modulation, a spectral shaping filter, an elastic transformation, an inelastic transformation, and a geophysical model transformation. In another embodiment, two pieces of data are blended together to generate a new piece of data. Other geophysical augmenting methods may also be used to generate augmented data. The labels may be preserved or modified in the augmentation. In this way, the data set size may be augmented to improve the model by introducing variations of data without requiring resources of acquiring and labelling field-acquired data or generating new synthetic data. Preferably, the augmented data is generated by a test-time augmentation technique.

The training data set is used to train a backpropagation-enabled process to predict a contained column height and/or a fluid flow capacity at a fault juxtaposition location. Examples of backpropagation-enabled processes include, without limitation, artificial intelligence, machine learning, and deep learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled processes, even if not expressly named herein.

A preferred embodiment of a backpropagation-enabled process is a deep learning process, including, but not limited to a convolutional neural network.

The backpropagation-enabled process may be supervised, semi-supervised, or a combination thereof. In one embodiment, a supervised process is made semi-supervised by the addition of an unsupervised technique. In another embodiment, a subset of the seismic data is labelled in a semi-supervised process. Examples of a semi-supervised backpropagation-enabled process include, without limitation, a semi-supervised VAE process and a semi-supervised GAN process.

The training data set includes labels to provide examples of fault location, fault displacement, fault throw, fault heave, areas of cross-fault juxtaposition, relay ramp, lithology, shale layer thickness, displacement vector, subsurface pressure, fluid type, fluid density, fluid composition, stress orientation, geomechanical properties, structural closure against a fault, fluid production information, fluid injection information, and combinations thereof.

In one embodiment, the supervised backpropagation-enabled process is a classification process. The classification process may be conducted voxel-wise, slice-wise and/or volume-wise.

The method of the present invention may be used for static and/or dynamic fault analysis. Preferably, the method is used for a combined static and dynamic fault analysis.

A static fault analysis may identify weak and/or leaky parts of a fault seal, capillary properties, fault rock, and support for buoyancy pressure. For example, weak and/or leaky parts of a fault may result from sand/sand juxtaposition.

A dynamic fault analysis determines the quantity and flow rate of fluids across a fault from one reservoir to another. The analysis may change with time and is influenced by permeability and changes therein.

In accordance with the present invention, fault seal behaviour may be predicted by inferring the integrity of a fault seal and behaviour of a fault seal following fluid production and/or injection. By understanding the behaviour of a fault seal, a determination can be made regarding the suitability of a reservoir for fluid sequestration and/or for fluid production.

Accordingly, decisions about placement and/or operation of injection and/or production wells can be made more accurately and efficiently.

The backpropagation-enabled process is trained to predict a contained column height and/or a fluid flow capacity at a fault juxtaposition location. Once trained, the backpropagation-enabled process is then used on a non-training data set to predict a contained column height and/or a fluid flow capacity at a fault juxtaposition location. It will be understood by those skilled in the art, after reading the description and claims herein, that contained column height and/or fluid flow capacity may be predicted in a number of different ways, for example, depending on the type of seismic data and well data used for training and non-training data sets. For example, by predicting the presence of certain elements, such as a fault and a juxtaposition location, relevant properties, for example, SGR may be calculated for a fault juxtaposition location, to then calculate a contained column height and/or fluid flow capacity for a fault juxtaposition location.

Contained column height is influenced by several factors, including, without limitation, hydrodynamic tilted contacts, deformed paleocontacts, perched water, capillary properties of the reservoir, stratigraphic/diagenetic variability, and variation in hydrocarbon density. By training the backpropagation-enabled process according to the method of the present invention, a multitude of factors can be processed accurately and timely to produce a prediction of contained column height.

While preferred embodiments of the present invention have been described, it should be understood that various changes, adaptations, and modifications can be made therein within the scope of the invention(s) as claimed below.

What is claimed is:

1. A method for predicting fault seal behaviour, comprising the steps of:
providing a training data set of seismic data, well data, and associated labels, wherein the seismic data has at least three spatial dimensions and a seismic resolution, and wherein the well data has a vertical resolution greater than the seismic resolution;
training a backpropagation-enabled process using the training data set to predict one or more of a contained column height and a fluid flow capacity at a fault juxtaposition location, thereby producing a trained backpropagation-enabled process; and
using the trained backpropagation-enabled process in a non-training data set to predict one or more of a contained column height and a fluid flow capacity at a fault juxtaposition location.

2. The method of claim 1, wherein the training data set comprises field-acquired data, augmented data, synthetic data, and combinations thereof.

3. The method of claim 1, wherein the training data set comprises seismic data selected from the group consisting of 3D seismic data, 4D seismic data, 5D seismic data, 6D seismic data, and combinations thereof.

4. The method of claim 1, wherein the training data set comprises well data having at least 1D.

5. The method of claim 1, wherein the well data is selected from the group consisting of well log data, downhole fluid sampling, flow test, injectivity test, stress test, tracer testing, borehole imaging, core samples, and combinations thereof.

6. The method of claim 5, wherein the well log data is selected from the group consisting of acoustic logs, calliper logs, chemical logging, density logs, gamma logs, image logs, mud logging, neutron logging, pressure temperature logs, single-well and cross-well resistivity logs, and combinations thereof.

7. The method of claim 1, wherein the seismic resolution is in a range of from 20 to 250 m.

8. The method of claim 1, wherein the vertical resolution of the well data is in a range of from 1 cm to 5 m.

9. The method of claim 1, wherein the training data set further comprises a geologically realistic parameter selected from the group consisting of scaling relationships, burial depth, stress state, reactivation history, temperature, diagenesis, and combinations thereof.

10. The method of claim 1, wherein the backpropagation-enabled process infers a geologically realistic parameter selected from the group consisting of scaling relationships, burial depth, stress state, reactivation history, temperature, diagenesis, and combinations thereof.

11. The method of claim 1, wherein the associated labels provide examples selected from the group consisting of fault location, fault displacement, fault throw, fault heave, areas of cross-fault juxtaposition, relay ramp, lithology, shale layer thickness, displacement vector, subsurface pressure, fluid type, fluid density, fluid composition, stress orientation, geomechanical properties, structural closure against a fault, fluid production information, fluid injection information, and combinations thereof.

12. The method of claim 1, wherein the trained backpropagation-enabled process is used for static fault analysis, dynamic fault analysis, and combinations thereof.
